(19) United States
(12) Patent Application Publication
(10) Pub. No.: US 2007/0114349 A1
(43) Pub. Date: May 24, 2007

(54) Hanging hook

(76) Inventors: Stephen John Lawson, Surrey (CA); Christopher Isfeld, Mission (CA)

Correspondence Address: FREDERICK KAUFMAN, SUITE 403, 1937 PENDRELL ST., VANCOUVER, BC, V6G 1T4, CA

(21) Appl. No.: 11/282,833

(22) Filed: Nov. 21, 2005

(51) Int. Cl. F16B 45/00

(52) U.S. Cl. 248/304

(57) ABSTRACT

A hanging hook adaptable to furniture vertical panels provided with perforations or plates alike the latter. The diameter of perforations and the distance between a pair of successive perforations, which are vertically and consecutively disposed, due to longstanding use within the furniture art, are, conventionally, standard. The hanging hook has a mounting base and an arm member, the latter extending outwardly and, then, upwardly from the mounting base. The mounting base has an upper hole for a passage of a tapping screw to be inserted into a perforation and a lower feature, co vertical and sequential with respect to the upper hole, which lower feature can be either an inserting element projecting perpendicularly from the mounting base or a through hole for a tapping screw, as mentioned above. For obtaining a tight fit, the inserting element has a diameter somewhat larger than the diameter of the perforations.

### I. BACKROUND OF THE INVENTION

1. Field of the Invention

The present invention relates in general to hooks for hanging objects, and more particularly, to hanging hooks attachable to furniture vertical panels provided with perforations, or plates alike the latter.

2. Description of the Prior Art

Many articles of furniture, such as wardrobes, cupboards, cabinets, closets, bookcases etc. are, generally, provided with detachable/repositionable shelves. In these articles of furniture use is made of horizontal shelves anchored to and supported by a pair of vertical, end panels. To this end, each vertical, end panel of the pair of vertical, end panels (which will be referred to as an end panel) is provided with two columns of equally spaced, successive perforations. Each of these columns is disposed proximately and parallel to one of the two longitudinal margins of each end panel. A pair of pegs or pins is snugly inserted into two coplanar perforations belonging to the two columns of successive perforations of each end panel. Thus, two pairs of pegs or pins disposed in the same horizontal plane are adapted to engage an undersurface of each one of the several horizontal shelves. In general, the diameter of the perforations and the distance between two consecutive perforations in the two columns of successive perforations of each end panel are standard (5 mm and 32 mm, respectively). The diameter of the pegs or pins is adapted to match and snugly engage the interior of each of the mentioned perforations.

Hooks are used in a variety of different locations, wherein they are usually affixed or secured to a vertical surface in order to hold other objects. Such hooks are commonly attached to the vertical surface via mechanically engaging devices, adhesives, magnets, suction cups or over-the door fixtures.

All the hooks designed according to the present invention are intended to be attached to an end panel, described above, or to a plate similar to the latter.

The following disclosures relate to various types of hooks: Immerman (U.S. Pat. No. 6,749,165 issued Jun. 15, 2004); Caron (U.S. Published Application No. 2004108431, published Jun. 10, 2004); Cupper (G.B. Patent No. 2,389,873, published Dec. 24, 2003); Elbl et al. (DE Patent No. 10204375, published Aug. 14, 2003); Adams (U.S. Pat. No. 6,497,396, issued Dec. 24, 2002); Allbrighton (G.B. Patent No. 2,375,570, published Nov. 20, 2002); Lydecker et al. (U.S. Pat. No. 6,431,510, issued Aug. 13, 2002); Huang (DE Patent No. 10051607, published May 02, 2002); Fargo (U.S. Pat. No. 6,199,811, issued Mar. 13, 2001); Hart (U.S. Pat. No. 6,189,847, issued Feb. 20, 2001); Murken (DE Patent No. 19912736, issued Sep. 21, 2000); Hepworth (U.S. Pat. No. 6,086,030, issued Jul. 11, 2000); Steffen (DE Patent No. 19938476, published Mar. 09, 2000); Lai (U.S. Pat. No. 5,727, 698, issued Mar. 17, 1998); and Moreau et al. (FR Patent No. 2702941, published Sep. 30, 1994).

The inventors believe that the cited disclosures taken alone or in combination neither anticipate nor render obvious the present invention. The foregoing citation does not constitute an admission that such disclosures are relevant or material to the claimed subject matter. Rather, the disclosures relate only to the field of the invention and are cited as constituting the closest art of which the inventors are aware.

### II. SUMMARY OF THE INVENTION

There is accordingly a need for hanging hooks for mounting directly on furniture vertical panels provided with perforations, or plates alike the latter, namely, for hanging hooks that overcome the limitations of the prior art.

Thus, it is an objective of the present invention to design hanging hooks as to accommodate the standard distance and the diameter of vertically superposed perforations used in the panels of furniture items or the like.

There is another objective of the present invention to provide hanging hooks requiring no permanent attachment.

There is still another objective of the present invention to provide hanging hooks requiring no special tools for attaching.

Based on the foregoing objectives, the inventors developed hanging hooks, which they believe have an uncomplicated design, are reliable, functionally practical and may be formed, as one piece, of metal or plastic.

The present invention is directed to a hanging hook adaptable to be used with furniture vertical panels provided with perforations, or plates alike the latter. The diameter of each of the perforations and the distance between a pair of the perforations, which are vertically and consecutively disposed, due to longstanding use within the furniture art, are, conventionally, standard.

The hanging hook has a mounting base, structurally flat for engaging flush a surface of the furniture vertical panels, or of the plates alike the latter; and an arm member extending outwardly and then upwardly from the mounting base member, for forming a hook shaped portion.

The mounting base incorporates, firstly, in its upper part, a through hole, adaptable for the passage with a clearance of an element for attaching by tapping. The latter is further introduced, as a self-piercing element into one of the perforations. The diameter of the element for attaching by tapping is somewhat larger than the diameter of the perforations.

In addition, the mounting base incorporates, secondly, in its lower part, a feature, which is co vertically so disposed with respect to said through hole as to correspond to a sequential one of the perforations. The feature can be either an inserting element, formed as a pin that projects perpendicularly from the mounting base or a through hole for an element for attaching by tapping, as mentioned above. For obtaining a tight fit, the inserting element has a diameter somewhat larger than the diameter of the perforations.

### III. BRIEF DESCRIPTION OF THE DRAWINGS

The subject matter of the invention is particularly pointed out and distinctively claimed in the concluding portion of the specification. The invention, however, both in structure and operation may be better understood by reference to the following description taken in conjunction with the subjoined claims and the accompanying drawings of which:

FIG. 1 is a perspective view of a first embodiment of a hanging hook according to the present invention, ready for mounting on a furniture vertical panel provided with perforations;

FIG. 2 illustrates two-dimensional lateral and frontal views and perspective back and front views of the first embodiment of the hanging hook;

FIG. 3 illustrates a perspective view of several hanging hooks adaptable to be mounted on a plate with pairs of perforations, the latter having the standard distance and the diameter of vertically superposed perforations used in the panels of furniture items;

FIG. 4 illustrates one perspective view and two two-dimensional views/lateral and frontal/of a second embodiment of the hanging hook that incorporates two vertically successive through holes, each one with a chamfered entrance opening; and

FIG. 5 illustrates one perspective view and two two-dimensional views/lateral and frontal/of a third embodiment of the hanging hook having a hook shaped portion in the form of one hook.

### IV. DESCRIPTION OF THE PREFERRED EMBODIMENT

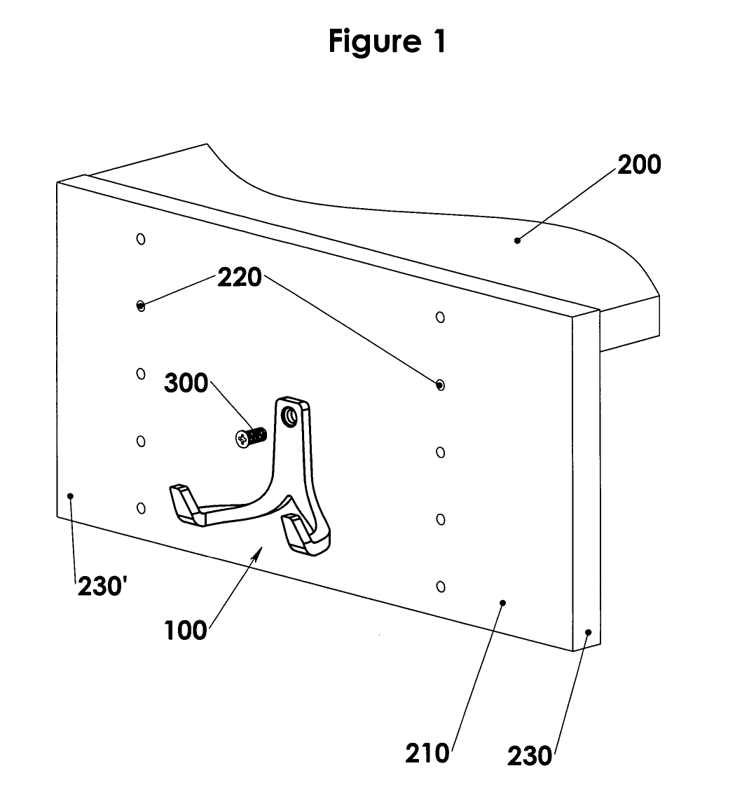

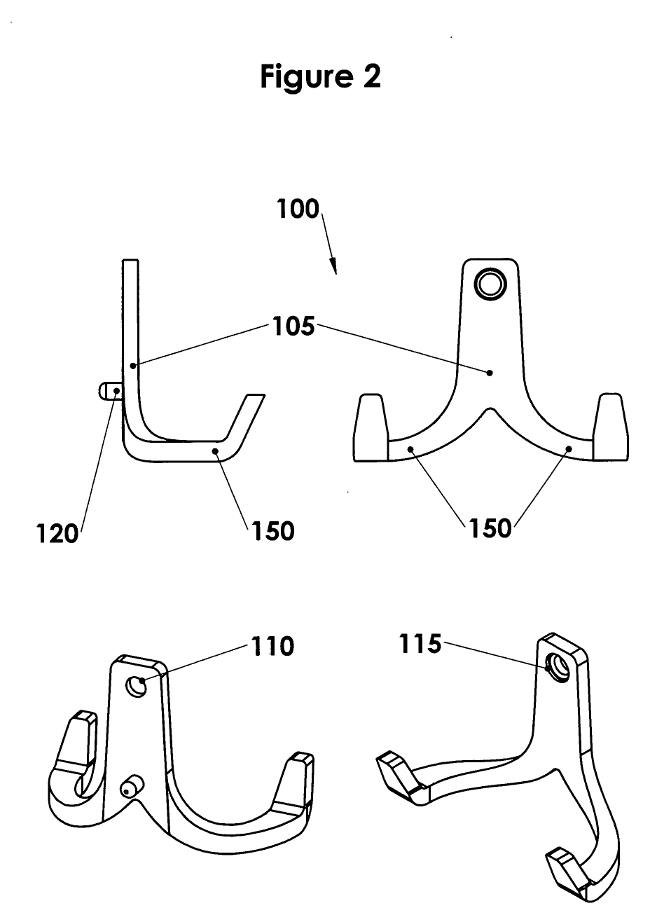

FIGS. 1 and 2 illustrate a first preferred embodiment of a hanging hook, generally designated by the numeral 100, adapted to be attached to of an article of furniture, generally designated by the numeral 200, respectively to an end panel 210 of the latter. According to this invention, end panel 210 is provided with two identical columns of equally spaced perforations 220 (hereinafter referred as perforations 220), each of the two identical columns extending vertically in proximity of one of longitudinal margins 230 and 230′. The diameter of each perforation 220 and the distance between two vertically and consecutively disposed perforations 220, due to longstanding use within the furniture art, are, conventionally, standard (5 mm and 32 mm, respectively).

Hanging hook 100 is a one-piece construction, designed for mounting directly to the end panel 210 provided with perforations 220 or a plate having the latter.

To this end, hanging hook 100 has a mounting base member 105, structurally flat for engaging flush against a vertical surface of end panel 210, and an arm member 150 extending outwardly and then upwardly from mounting base member 105, for forming a hook shaped portion (in the present embodiment is in the form of a pair of hooks). Mounting base member 105 incorporates a through hole 110 with a chamfered entrance opening 115. The diameter of through hole 110 is somewhat larger than the diameter of a flathead tapping screw 300, while the latter diameter is somewhat larger than the diameter of perforations 220. Chamfered entrance opening 115 is so dimensioned as to locate the head of flathead tapping screw 300.

An inserting element 120 is formed as a pin that projects perpendicularly from mounting base member 105 towards end panel 210. For obtaining a tight fit, inserting element 120 has, preferably, a diameter somewhat larger than the diameter of perforations 220. The geometrical centers of through hole 110 and inserting element 120 are so disposed on a common vertical line as to accommodate the distance between two perforations 220, successively disposed in the same column.

In the present embodiment, through hole 110 is vertically situated above inserting element 120, and flathead tapping screw 300 is introduced, via through hole 110, into a perforation 220; simultaneously inserting element 120 is sequentially fitted in a lower perforation 220. When a torque, due to a load, is applied to arm member 150, the latter being a cantilever element tends to pivot downwardly around inserting element 120 fitted already in a perforation 220.

Consequently, flathead tapping screw 300 is located above inserting element 120 to, generally, withstand a pulling force resulting from the applied torque.

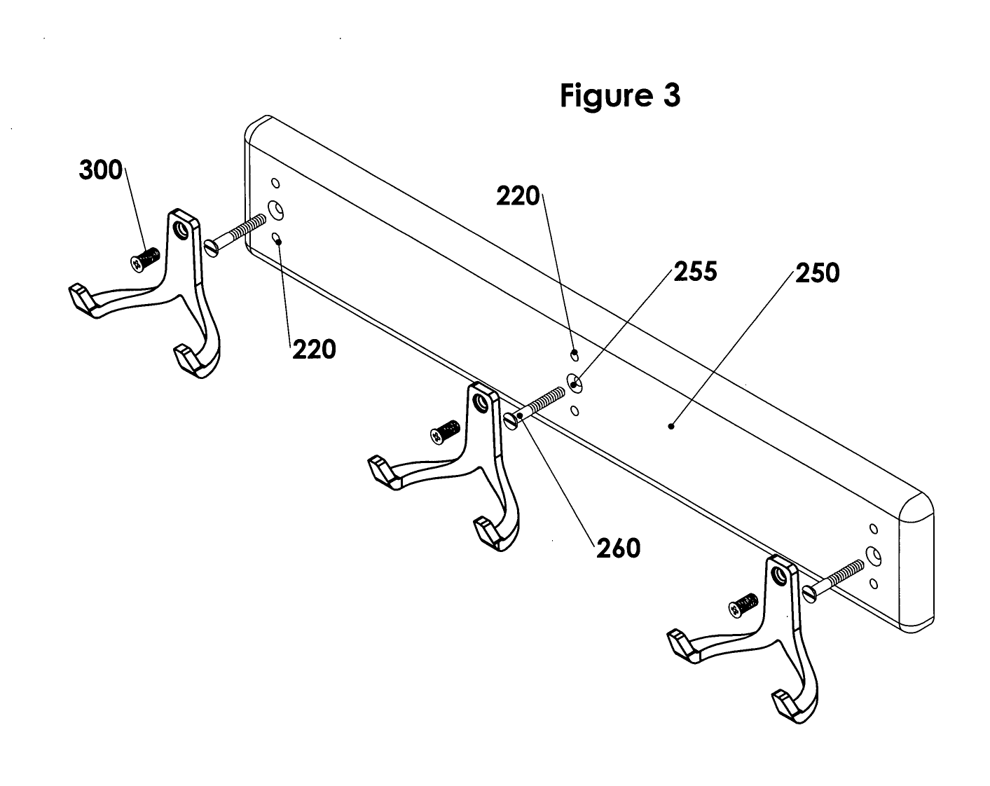

As seen in FIG. 3, alternatively to end panel 210 belonging to an article of furniture 200, a plate 250, provided with three pairs of perforations 220, each pair being constituted of successively and vertically located perforations 220, is used. Between each pair of perforations 220 there is a bore 255. Plate 250 can be secured to a wall (not shown) with anchoring screws 260.

The foregoing hanging hook 100 is adaptable to be used with plate 250 in the same manner as it has been used with end panel 210.

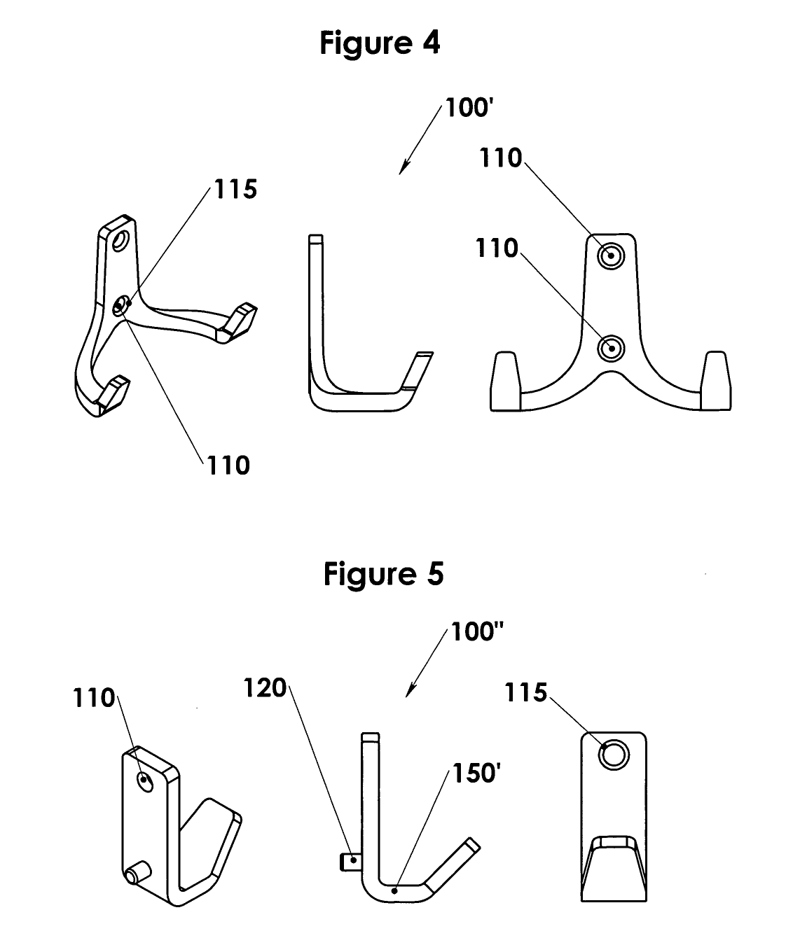

A second embodiment 100′ of a hanging hook is shown in three views in FIG. 4. In hanging hook 100′, inserting element 120 is replaced by a through hole 110 provided with a chamfered entrance opening 115. Thus, hanging hook 100′ incorporates two vertically successive through holes 110, each one with a chamfered entrance opening 115.

A third embodiment 100″ of a hanging hook is illustrated in FIG. 5. Hanging hook 100″ comprises an arm member 150′ extending outwardly and then upwardly from mounting base member 105, for forming a hook shaped portion (in the present embodiment is in the form of one hook). Hanging hook 100″ is provided with a through hole 110 with a chamfered entrance opening 115, vertically disposed above an inserting element 120. The latter horizontally projects from mounting base member 105 towards end panel 210 or plate 250.

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as representative basis for teaching one skilled in the art to variously employ the present invention in virtually any appropriately detailed structure.

What is claimed is:

1. A hanging hook adaptable to be used with furniture vertical panels provided with perforations, or plates alike the latter, the diameter of each of said perforations and the distance between a pair of said perforations, vertically and consecutively disposed, due to longstanding use within the furniture art, being, conventionally, standard;
said hanging hook having
a mounting base, structurally flat for engaging flush a surface of said furniture vertical panels, or of said plates alike the latter; and
an arm member extending outwardly and then upwardly from said mounting base member, for forming a hook shaped portion,
said mounting base incorporating, firstly, in its upper part, a through hole, having a diameter somewhat larger than the diameter of a tapping screw, while the latter diameter is somewhat larger than the diameter of said perforations and, in addition,
said mounting base incorporating, secondly, in its lower part, a feature, which is co vertically so disposed with respect to said through hole as to correspond to a sequential one of said perforations, said feature being selected from the group consisting of said through hole and an inserting element, said through hole being adapted to be used for the same purpose as above, while said inserting element is formed as a pin that projects perpendicularly from said mounting base and is adapted to be inserted into said sequential one of said perforations and, for obtaining a tight fit, said inserting element has a diameter somewhat larger than the diameter of said perforations.
